(19) United States
(12) Patent Application Publication
(10) Pub. No.: US 2019/0162137 A1
(43) Pub. Date: May 30, 2019

(54) ROTARY THROTTLE VALVE CARBURETOR WITH VALVE BORE AIR FLOW

(71) Applicant: Walbro LLC, Tucson, AZ (US)

(72) Inventors: Taketoshi Hirama, Watari-gun (JP); Takumi Konarita, Shibata-Gun (JP)

(21) Appl. No.: 16/204,250

(22) Filed: Nov. 29, 2018

Related U.S. Application Data
(60) Provisional application No. 62/591,991, filed on Nov. 29, 2017.

(51) Int. Cl. F02M 9/08; F02M 19/02; F02M 9/12

(52) U.S. Cl. CPC F02M 9/085; F02M 9/121; F02M 19/02

(57) ABSTRACT

In at least some implementations, a carburetor includes a main bore and a valve bore that has a bottom wall, and a throttle valve is received within the valve bore for rotation and axial movement between an idle position and a wide-open position. A first chamber is defined in the valve bore between the bottom wall and the throttle valve, and a second chamber is defined at least partially in the valve bore between the throttle valve and the throttle valve plate. A first passage communicates with the first chamber to permit fluid flow into or out of the first chamber, and a second passage communicates with the second chamber to permit fluid flow into or out of the second chamber. Various implementations may use any combination of inlet passages to the first and/or second chamber, and outlet passages from the first and/or second chamber.

### REFERENCE TO RELATED APPLICATIONS

This application claims the benefit of U.S. Provisional Application Ser. No. 62/591,991 filed on Nov. 29, 2017, the entire contents of which is incorporated herein by reference in its entirety.

### TECHNICAL FIELD

The present disclosure relates generally to a rotary throttle valve carburetor.

### BACKGROUND

A rotary throttle valve carburetor for use in small internal combustion engines such as lawn mowers, motor scooters and the like includes a cylindrical rotary throttle valve with a valve passage that is selectively and variably registered with a mixing passage of the carburetor by rotating the throttle valve about an axis generally perpendicular to the mixing passage. A needle valve extends into the passage of the rotary valve, and a fuel nozzle projects into the mixing passage and slidably receives the tip of the needle valve. The needle is carried by a first portion of the throttle valve body which is coupled to a second portion of the throttle valve body in which the valve passage is formed. A valve bore intersects the mixing passage and the throttle valve is rotatably received in the valve bore.

### SUMMARY

In at least some implementations, a rotary throttle valve carburetor includes a main body having a main bore through which a fuel and air mixture is discharged, and a valve bore that intersects the main bore and has a bottom wall. A throttle valve plate is coupled to the main body and has an opening aligned with the valve bore, and a throttle valve is received within the valve bore for rotation and axial movement between an idle position and a wide-open position. The throttle valve is closer to the bottom wall in the idle position than in the wide-open position, and the throttle valve extends into the opening in the throttle valve plate. A first chamber is defined in the valve bore between the bottom wall and the throttle valve, and a second chamber is defined at least partially in the valve bore between the throttle valve and the throttle valve plate. A first passage communicates with the first chamber to permit fluid flow into or out of the first chamber, and a second passage communicates with the second chamber to permit fluid flow into or out of the second chamber.

In at least some implementations, the first passage has an inlet that is upstream of the throttle valve relative to a direction of fluid flow through the main bore and an outlet that is open to the valve bore, and the second passage has an inlet that is upstream of the throttle valve relative to a direction of fluid flow through the main bore and an outlet that is open to the valve bore.

In at least some implementations, the first passage has an inlet that is upstream of the throttle valve relative to a direction of fluid flow through the main bore and an outlet that is open to the valve bore, and the second passage has an outlet that is downstream of the throttle valve relative to a direction of fluid flow through the main bore and an inlet that is open to the valve bore.

In at least some implementations, the first passage has an outlet that is downstream of the throttle valve relative to a direction of fluid flow through the main bore and an inlet that is open to the valve bore, and the second passage has an inlet that is upstream of the throttle valve relative to a direction of fluid flow through the main bore and an outlet that is open to the valve bore.

In at least some implementations, the first passage has an outlet that is downstream of the throttle valve relative to a direction of fluid flow through the main bore and an inlet that is open to the valve bore, and the second passage has an outlet that is downstream of the throttle valve relative to a direction of fluid flow through the main bore and an inlet that is open to the valve bore.

In at least some implementations, a rotary throttle valve carburetor, includes a main body having a main bore through which a fuel and air mixture is discharged, and a valve bore that intersects the main bore and has a bottom wall. A throttle valve plate is coupled to the main body and has an opening aligned with the valve bore, and a throttle valve is received within the valve bore for rotation and axial movement between an idle position and a wide-open position. The throttle valve is closer to the bottom wall in the idle position than in the wide-open position, and the throttle valve extends into the opening in the throttle valve. A first chamber is defined in the valve bore between the bottom wall and the throttle valve, and a second chamber is defined in the valve bore between the throttle valve and the throttle valve plate. At least one passage communicates with either the first chamber or the second chamber to permit fluid flow into or out of the first chamber or the second chamber, wherein the at least one passage is open when the throttle valve is in any position between and including the idle position and wide-open position.

In at least some implementations, the at least one passage has an inlet that is upstream of the throttle valve relative to a direction of fluid flow through the main bore and an outlet that is open to the first chamber. In at least some implementations, the at least one passage has an inlet that is upstream of the throttle valve relative to a direction of fluid flow through the main bore and an outlet that is open to the second chamber. In at least some implementations, the at least one passage has an outlet that is downstream of the throttle valve relative to a direction of fluid flow through the main bore and an inlet that is open to the first chamber. In at least some implementations, the at least one passage has an outlet that is downstream of the throttle valve relative to a direction of fluid flow through the main bore and an inlet that is open to the second chamber.

In at least some implementations, the at least one passage includes a first passage communicating with the first chamber to permit fluid flow into or out of the first chamber, and a second passage communicating with the second chamber to permit fluid flow into or out of the second chamber. The first passage may have an inlet that is upstream of the throttle valve relative to a direction of fluid flow through the main bore and an outlet that is open to the valve bore, and the second passage may have an outlet that is downstream of the throttle valve relative to a direction of fluid flow through the main bore and an inlet that is open to the valve bore. The first passage may have an outlet that is downstream of the throttle valve relative to a direction of fluid flow through the main bore and an inlet that is open to the valve bore, and the second passage may have an inlet that is upstream of the throttle valve relative to a direction of fluid flow through the main bore and an outlet that is open to the valve bore. The first passage may have an outlet that is downstream of the throttle valve relative to a direction of fluid flow through the main bore and an inlet that is open to the valve bore, and the second passage may have an outlet that is downstream of the throttle valve relative to a direction of fluid flow through the main bore and an inlet that is open to the valve bore.

In at least some implementations, the at least one passage includes a first passage having an inlet that is upstream of the throttle valve relative to a direction of fluid flow through the main bore and an outlet that is open to the first chamber, and a second passage having an outlet that is downstream of the throttle valve relative to a direction of fluid flow through the main bore and an inlet that is open to the first chamber. The at least one passage may include a third passage having an inlet that is upstream of the throttle valve relative to a direction of fluid flow through the main bore and an outlet that is open to the second chamber. The at least one passage may include a fourth passage having an outlet that is downstream of the throttle valve relative to a direction of fluid flow through the main bore and an inlet that is open to the second chamber.

In at least some implementations, the at least one passage includes a first passage having an inlet that is upstream of the throttle valve relative to a direction of fluid flow through the main bore and an outlet that is open to the second chamber, and a second passage having an outlet that is downstream of the throttle valve relative to a direction of fluid flow through the main bore and an inlet that is open to the second chamber.

It is contemplated that the various features set forth in the preceding paragraphs, in the claims and/or in the following description and drawings may be taken independently or in any combination. For example, features disclosed in connection with one embodiment or implementation are applicable to all embodiments or implementations, except where there is incompatibility of features.

### BRIEF DESCRIPTION OF THE DRAWINGS

The following detailed description of certain embodiments and best mode will be set forth with reference to the accompanying drawings, in which:

FIG. 1 is a sectional view of a rotary throttle valve carburetor with a throttle valve shown in an idle position;

FIG. 2 is a sectional view of the carburetor showing the throttle valve in a wide-open position;

FIG. 3 is a perspective view of a main body of the carburetor; and

FIG. 4 is a sectional view of the main body of the carburetor.

### DETAILED DESCRIPTION

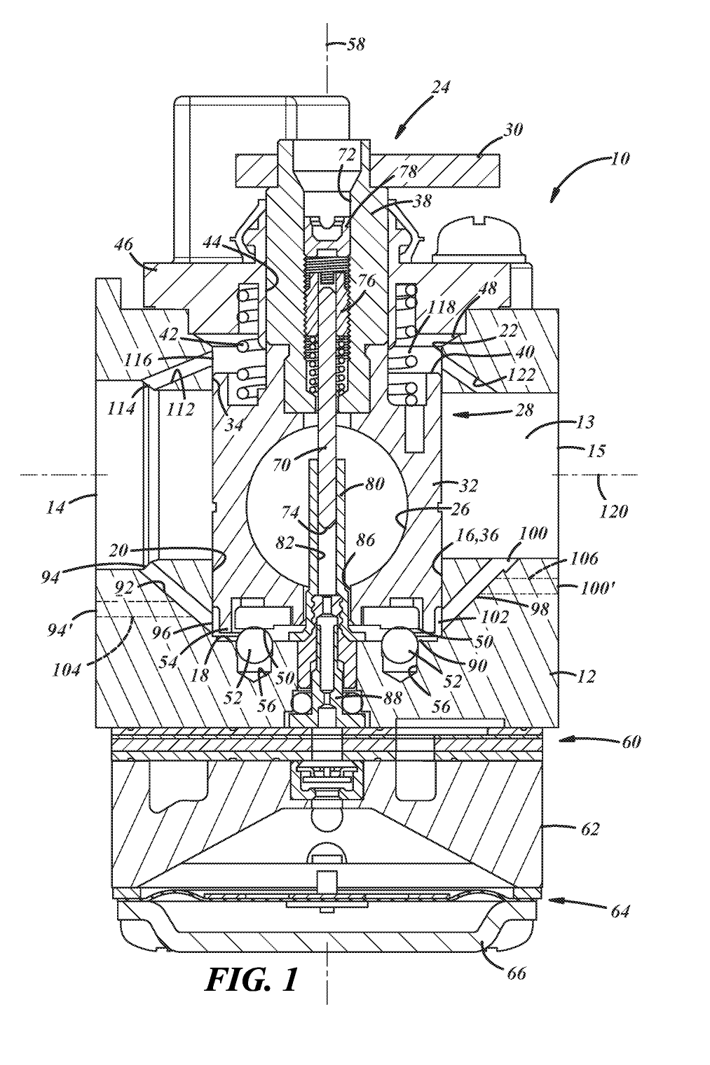

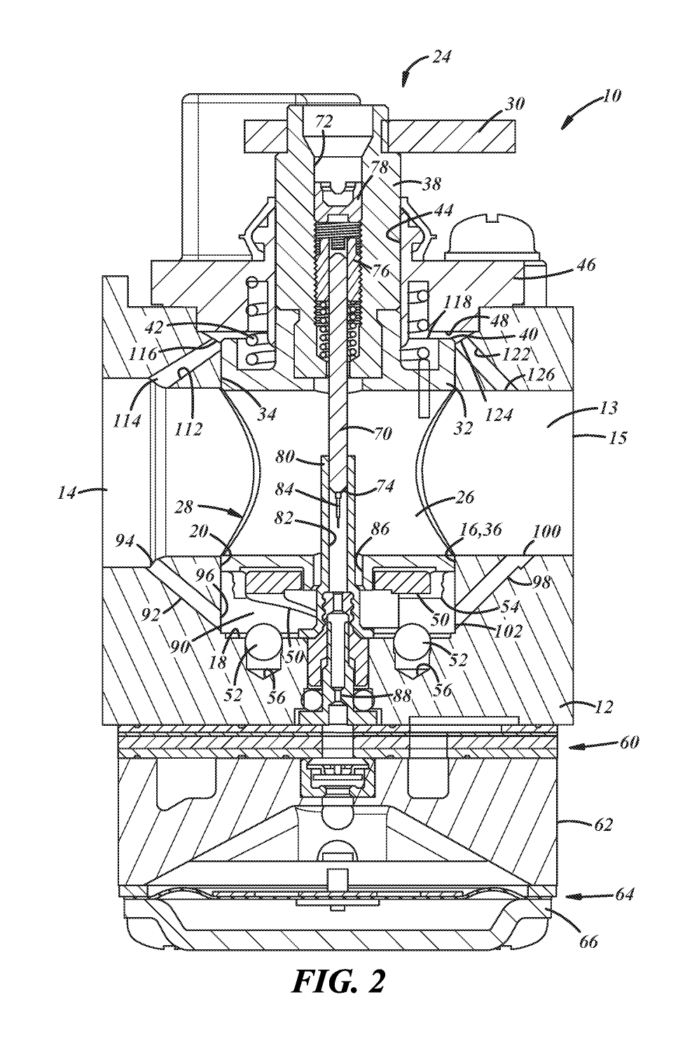

Referring in more detail to the drawings, FIGS. 1 and 2 illustrate a rotary throttle valve carburetor 10 that includes a carburetor main body 12 provided with a main bore 13. Air enters the main bore 13 at an inlet end 14, the air is mixed with fuel provided into the main bore 13, and a fuel and air mixture flows out of an outlet end 15 of the main bore 13 for delivery to an engine.

The carburetor main body 12 also includes a throttle valve bore 16 that intersects and may extend perpendicular to the main bore 13. The valve bore 16 may be a blind bore that is closed or dead-ends at a bottom wall 18 and has a generally cylindrical sidewall 20 that leads to an opening 22 at the end opposite the bottom wall 18. The bottom wall 18 may be located on one side of the main bore 13 and the opening 22 may be located on an opposite side of the main bore 13 from the bottom wall 18. Hence, an axial length of the sidewall 20 is interrupted by the main bore 13. The main body 12 may be formed of cast metal, such as diecast aluminum, or by other suitable methods and materials known in the art.

A rotary throttle valve 24 is rotatably and axially movably received in the valve bore 16 and includes an intake or valve passage 26 therethrough that is variably aligned or registered with the main bore 13 as the throttle valve 24 is rotated to selectively open and close the main bore 13. Rotation of the throttle valve 24 causes both the valve passage 26 to align or mis-align longitudinally with the main bore 13, and the throttle valve 24 to move axially within the valve bore 16 under control of a cam interface as will be described below (and with reference to the orientation of the carburetor shown in the drawings). The throttle valve 24 includes a valve body 28 and a throttle lever 30 coupled to the valve body 28.

The throttle valve body 28 may include a first portion 32 that is generally cylindrical and has an outer diameter sized for close receipt within the throttle valve bore 16. The first portion 32 may have an axial length such that part of the first portion 32 is received within an upper portion 34 of the valve bore 16 (defined between the main bore 13 and the opening 22) and part of the first portion 32 is received within a lower portion 36 of the valve bore 16 (defined between the main bore 13 and bottom wall 18). The valve body 28 may include a second portion 38 that is fixed to the first portion 32 so that the portions co-rotate. The second portion 38 may be generally cylindrical and may extend outwardly from the opening 22 of the valve bore 16. If desired, the second portion 38 may have a smaller outer diameter than the first portion 32, providing a circumferential shoulder 40 of the first portion 32 that is radially outboard of the second portion 38. A biasing member, shown as a coil spring 42, may engage the shoulder 40 and provide a force that tends to move the throttle valve 24 toward the bottom wall 18. The second portion 38 may be supported and rotatably journaled in an opening 44 formed in a throttle valve plate 46 that is coupled to the carburetor main body 12. The second portion 38 may extend through the opening 44 in the valve plate 46 and the throttle valve lever 30 may be coupled to the second portion 38 outboard of the throttle valve plate 46, that is, on the opposite side of the plate 46 than the main bore 13. Some clearance is provided between an inner surface 48 of the plate 46 (i.e. the surface facing the main bore 13) and the shoulder 40 of the throttle valve body 28, to permit movement of the throttle valve 24 within the valve bore 16 and relative to the plate 46, as set forth below.

The throttle valve lever 30 is coupled to an actuator (which may be a wire of a control or Bowden cable) that is actuated to rotate the throttle valve 24 toward a wide-open throttle position wherein the valve passage 26 is nearly or completely aligned with the main bore 13. As is known in the art, the plate 46 may carry a stop surface that is engaged by the throttle valve lever 30 to define the idle position of the throttle valve 24. The stop surface may be movable relative to the plate 46 to permit adjustment of the idle position of the throttle valve 24, if desired.

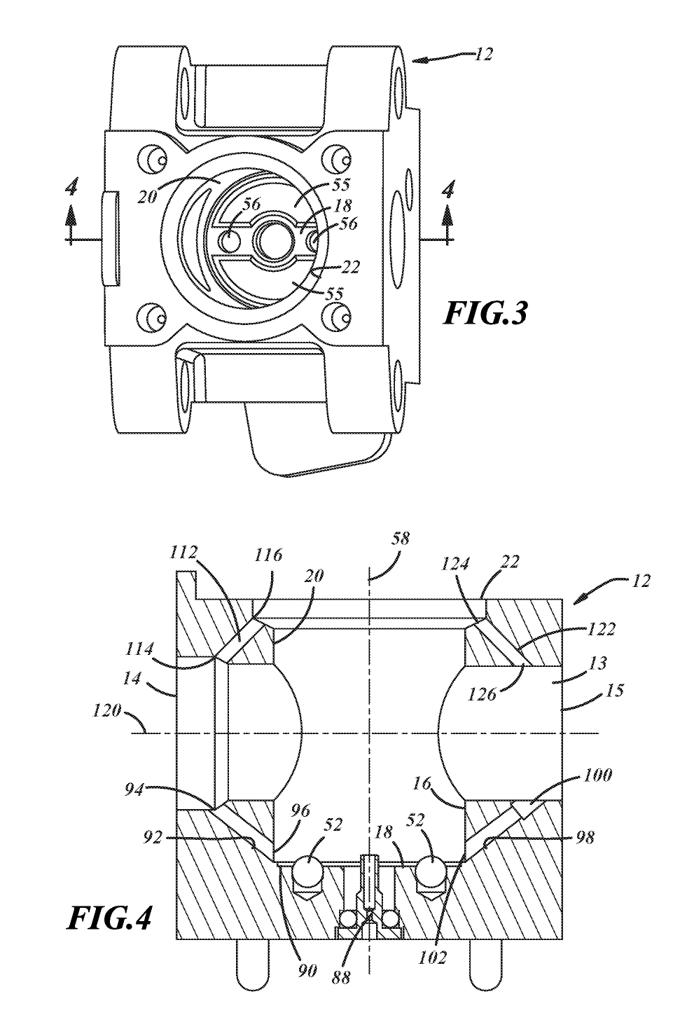

As the throttle valve 24 is rotated toward its wide-open position (FIG. 2) a cam surface 50 defined on or carried by the throttle valve body 28 rides over a cam follower 52, which carried by the carburetor main body 12. In the example shown, two cam surfaces 50 are formed in an insert fixed to the bottom 54 of the first portion 32 of the throttle valve body 28 (or may be formed in a bottom surface of the first portion) and may be received in slots 55 (FIG. 3) in the bottom wall 18. The cam surfaces 50 are engaged with one or more cam followers 52, which are shown as two spherical balls, pressed into cavities 56 in the bottom wall 18 of the valve bore 16 in the main body 12. Of course, the cam surface 50 could be carried by or defined in the bottom wall 18 and the followers 52 or balls could be carried by the valve body 28. And other arrangements may be used, for example, the cam may be associated with the throttle valve lever 30, or with the upper portion of the throttle valve body 28 and the valve plate 46, as desired. The slope of the cam surface 50 causes the throttle valve 24 to move axially away from the bottom wall 18 of the valve bore 16 (relative to the axis of rotation 58 (FIGS. 1 and 4) of the throttle valve 24, which is the axis of the valve bore) during rotation of the throttle valve 24 toward the wide-open position. As the throttle valve 24 rotates toward its idle position, the throttle valve 24 moves axially toward the bottom wall 18 of the valve bore 16. The spring 42 that biases the throttle valve 24 toward the bottom wall 18 ensures that the cam surface 50 remains engaged with the cam followers 52, and also, due to the slope of the cam surface 50, yieldably rotationally biases the throttle valve 24 toward its idle position.

In conventional manner, the carburetor 10 may include a fuel pump assembly 60 arranged or defined at least in part between a first plate 62 and the main body 12, and a fuel metering assembly 64 arranged or defined at least in part between a second plate 66 and the first plate. The fuel metering assembly 64 and fuel pump assembly 60 may each include separate diaphragms and valves to control fuel flow within and among these assemblies, as is known in the art. Fuel flows from the fuel pump assembly 60 to the fuel metering assembly 64, and from the fuel metering assembly 64 to the main bore 13.

As shown in FIGS. 1 and 2, to vary the fuel flow in and from the carburetor 10, the throttle valve 24 may carry a needle 70. The needle 70 may be carried by the throttle valve body 28 and is shown as being carried in a central bore 72 of the second portion 38 of the throttle valve body 28. The needle 70 extends into the valve passage 26 and has a distal or free end 74 that is located in the valve passage 26. The needle 70 may be adjustably received by a threaded carrier 76 that is threadedly received in the bore 72 of the second portion 38 of the throttle valve body 28. Hence, rotation of the carrier 76 axially moves the needle 70 relative to the throttle valve body 28 so that the needle 70 is moved relative to the valve passage 26. A plug 78 may prevent further adjustment of the needle 70 after it is moved to a desired or calibrated position, if desired. The plug 78 may also permit some limited adjustment of the needle 70, if desired. As the throttle valve 24 moves axially, the position of the needle 70 relative to the main bore 13 changes. To control fuel flow into the main bore 13, the needle 70 is received within and is moved relative to a main fuel nozzle 80.

The main fuel nozzle 80 may be carried by the main body 12 and may have a passage 82 in which the needle 70 is received and a fuel outlet 84 (FIG. 2) that is, in at least some positions of the throttle valve 24, at least partially blocked by the needle 70. The main fuel nozzle 80 may extend through a bore 86 in the throttle valve body 28 that intersects or opens into the valve passage 26 so that the fuel outlet 84 is received within the valve passage 26. The main fuel nozzle 80 may include or be communicated with a fuel jet or restriction 88 located between the fuel outlet 84 and the fuel metering assembly 64, to provide a restricted fuel flow from the metering assembly 64 to the fuel outlet 84, if desired.

As the throttle valve 24 rotates and moves axially within the valve bore 16, the needle 70 moves with the throttle valve 24 and slides axially within the passage 82 in the main fuel nozzle 80 and relative to the fuel outlet 84 thereby adjusting or changing the effective size or flow area of the fuel outlet 84. In addition, rotation of the throttle valve 24 adjusts the degree or extent of communication between the main bore 13 and the valve passage 26 directly effecting the amount of air flow through the main bore 13. Generally, the higher the vertical position of the throttle valve 24 (e.g. the farther the throttle valve 24 is moved away from the bottom wall 18), the greater the airflow through the main bore 13, the larger the fuel outlet 84 flow area, and the greater the fuel flow into the valve bore 16 and out of the main bore 13.

As shown in FIGS. 1, 2 and 4, to provide air flow into the valve bore 16, specifically into a first chamber 90 that is defined between the bottom wall 18 and the main body 12 of the throttle valve 24, a first passage, which may be called an inlet passage 92, may be provided in the carburetor main body 12. The inlet passage 92 may communicate the first chamber 90 with an upstream portion of the main bore 13 which is a portion of the main bore 13 that extends from the main bore 13 inlet to the valve bore 16. The inlet passage 92 may have an inlet 94 communicated with the upstream portion of the main bore 13 and an outlet 96 that is open to or communicated with the first chamber 90. The inlet passage 92, specifically the outlet 96, may be communicated with the first chamber 90 in all positions of the throttle valve 24. That is, even when the throttle valve 24 is in the idle position wherein the first chamber 90 has its smallest volume, the inlet passage 92 may communicate with the first chamber 90. Accordingly, upstream of the throttle valve 24, air is directed to the first chamber 90.

To enable fluid flow out of the first chamber 90, a second passage, which may be called an outlet passage 98 may be provided in the carburetor main body 12. The outlet passage 98 may communicate the first chamber 90 with a downstream portion of the main bore 13, which is a portion of the main bore 13 that leads from the valve bore 16 to the main bore outlet 15. The outlet passage 98 may have an outlet 100 that is communicated with the outlet portion of the main bore 13 and an inlet 102 that is open to or communicated with the first chamber 90. The outlet passage 98 may communicate with the first chamber 90 in all positions of the throttle valve 24. That is, even when the throttle valve 24 is in the idle position wherein the first chamber 90 has its smallest volume, the outlet passage 98 may communicate with the first chamber 90 to permit fluid flow out of the first chamber 90. While the inlet 94 of the inlet passage 92 is shown as being open to the main bore 13, an inlet 94′ could instead open to or through the inlet side of the main body 12 (as shown in dashed lines 104 in FIG. 1), assuming air is provided to the inlet 94′ separate from the main bore 13. And while the outlet 100 of the outlet passage 98 is shown as being open to the main bore 13, an outlet 100′ could instead open to or through the outlet side of the main body 12 (as shown in dashed lines 106), assuming the outlet 100′ is communicated with a component downstream of the carburetor 10 such as an intake manifold of an engine. In this way, either or both of the inlet passage 92 and outlet passage 98 may be independent of the main bore 13 (which means not directly communicated therewith, recognizing that the valve bore 16 may communicate with the main bore 13 and hence, the inlet and outlet passages are indirectly communicated with the main bore 13 via the throttle valve bore 16).

In use, fuel may leak or flow from the valve passage 26 between the main nozzle 80 and the throttle valve body 28, and into the first chamber 90. In at least some situations, a relatively large volume of fuel may collect in the first chamber 90, and if that volume of fuel is discharged from the first chamber 90 too quickly, the engine may temporarily receive too rich of a fuel and air mixture which can affect engine operation. For example, during a comedown situation in a carburetor without the inlet and/or outlet passage, when the throttle valve is rotating back toward its idle position in an attempt to decrease the engine speed and/or power, the first chamber 90 becomes smaller as the throttle valve 24 moves toward the bottom wall 18 of the valve bore 16 and fuel within the first chamber 90 is displaced from the first chamber 90 by the throttle valve body 28. This displaced fuel flows through the main bore 13 to the engine and can inhibit the engine from slowing down as desired, and/or result in too rich of a fuel mixture to the engine which can decrease fuel economy and/or increase emissions from the engine.

To prevent this unintended rich fuel mixture from being delivered to the engine, the inlet passage 92 provides air into the first chamber 90 and the outlet passage 98 permits air and fuel in the first chamber 90 to flow out of the first chamber 90 to inhibit the collection of any significant volume of fuel in the first chamber 90. In at least some implementations, this occurs in all positions of the throttle valve 24, even the idle position in which the first chamber 90 has its minimum volume to prevent an undesirably rich fuel mixture from being delivered to the engine when the engine is idling and provide a more uniform and stable idle engine operation. Further, a more stable engine comedown can also be achieved by limiting the volume of fuel that may collect or reside in the first chamber 90. Accordingly, at least some of the fuel that flows into the first chamber 90 is removed from the first chamber 90 with air that flows into and through the first chamber 90 to reduce the volume of fuel within the chamber at any given time.

To communicate the inlet and outlet passages with the first chamber 90, the outlet 96 of the inlet passage 92 and the inlet of the outlet passage 98 may have at least a portion that is axially below the lower edge of the first portion 32 of the throttle valve body 28 so that the outlet 96 and inlet communicate with the first chamber 90 below the throttle valve body 28 even when the throttle valve 24 is in the idle position. Or, the throttle valve body 28 may include a recessed portion at or adjacent to the lower edge, wherein the recessed portion has a smaller outer diameter and a gap that is open to or communicated with the first chamber 90 is provided between the throttle valve body 28 and the valve 16 in the area of the recessed portion. The outlet 96 and inlet may communicate with the valve bore 16 in the area where the gap is located when the throttle valve 24 is in the idle position. In at least some implementations, no movement of the throttle valve 24 away from its idle position is needed to communicate one or both of the inlet and outlet passages with the first chamber 90.

As shown in FIG. 1, a third passage, which may be called a second inlet passage 112, may be provided spaced from the first inlet passage 92. The second inlet passage 112 may have an inlet 114 that communicates with the inlet portion of the main bore 13, or with the inlet side of the carburetor body (e.g. to receive an air flow separate from the main bore 13, if desired). The second inlet passage 112 may have an outlet 116 that communicates with a second chamber 118 that is defined within the valve bore 16 between the throttle valve body 28 and the throttle valve plate 46. The second inlet passage 112 is circumferentially spaced from the first inlet passage 92 (relative to the axis 120 (FIGS. 1 and 4) of the main bore 13) and may be generally diametrically opposed to the first inlet passage 92, if desired (wherein generally means within 20 circumferential degrees of diametrically opposed). In at least some implementations, the engine may be used in different orientations, and fuel may collect in the second chamber 118 in at least some orientations of the engine. Or it may be desirable to provide air flow into the second chamber 118 for other reasons. To provide air flow into the second chamber 118, the inlet 114 of the second inlet passage 112 may communicate with a supply of air upstream of the throttle valve 24 and the outlet 116 of the second inlet passage 112 may communicate with the second chamber 118, as generally set forth above with regard to the first inlet passage 92 and its inlet 94 and outlet 96. The air flow into the second chamber 118 from the second inlet passage 112 may dry out or prevent fuel from collecting in the second chamber 118. Some air may leak from the second chamber 118 into the main bore 13 through a gap or clearance between the throttle valve body 28 and the surface defining the valve bore 16.

Further, a fourth passage, which may be called a second outlet passage 122, may also be provided. The second outlet passage 122 may have an inlet 124 that communicates with the second chamber 118 and an outlet 126 that communicates with a downstream portion of the main bore 13 or with the outlet side of the carburetor main body 12. Thus, fluid flow out of the second chamber 118 may be accommodated through the second outlet passage 122, generally as set forth above with regard to the first outlet passage 98 and first chamber 90. One or both of the second inlet passage 112 and second outlet passage 122 may communicate with the second chamber 118 in all positions of the throttle valve 24, even in the wide-open position of the throttle valve 24 in which the second chamber 118 has its minimum volume. The second inlet passage 112 may be separate from and does not intersect the first inlet passage 92, and the second outlet passage 122 may be separate from and does not intersect the first outlet passage 98.

Accordingly, any combination of the four passages 92, 98, 112, 122, including all four of the passages can be provided. In at least some implementations, at least one passage communicates with the first chamber 90 and at least one passage communicates with the second chamber 118. In one example, only the first and third passages are provided, that is, the first inlet passage 92 and the second inlet passage 112—an outlet passage is not needed to permit fluid flow out of the chambers. Instead of flowing out of the first chamber 90 through the second passage 98 (which is not provided in this example) the air and any fuel may flow out of the first chamber 90 to the valve passage 26 between the main fuel nozzle 80 and the throttle valve body 28, or into the main bore 13 between the throttle valve body 28 and the carburetor main body 12. Similarly, air may flow out of the second chamber 118 and into the main bore 13 via a gap between the throttle valve body 28 and the carburetor main body 12. In at least some implementations, an inlet and an outlet passage communicate with the first chamber 90 that is, the first passage 92 and second passage 98 are provided. A carburetor may include the first, second and third passages 92, 98, 112 as well. A carburetor may include only one of the passages 92 or 98 or 112 or 122 and not the other passages, and hence, provide flow in to or out of only one of the chambers 90, 118. Any or all of the passages in a given implementation may communicate with their respective one of the first chamber 90 and second chamber 118 in any position of the throttle valve 24, if desired. Further, if desired, more than one passage may be provided that permits the same flow as another passage described above, and such passages may be circumferentially spaced apart relative to the axis of the main bore 13. This may increase the fluid flow in that direction and to or from that chamber, if desired. For example, more than one passage may be provided that has an inlet upstream of the throttle valve 24 and an outlet that communicates with the first chamber 90. Otherwise, the passages can be made of any size and shape to provide a desired fluid flow through them.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

1. A rotary throttle valve carburetor, comprising:
a main body having a main bore through which a fuel and air mixture is discharged, and a valve bore that intersects the main bore and has a bottom wall;
a throttle valve plate coupled to the main body and having an opening aligned with the valve bore;
a throttle valve received within the valve bore for rotation and axial movement between an idle position and a wide-open position, and wherein the throttle valve is closer to the bottom wall in the idle position than in the wide-open position, and the throttle valve extends into the opening in the throttle valve plate;
a first chamber defined in the valve bore between the bottom wall and the throttle valve;
a second chamber defined at least partially in the valve bore between the throttle valve and the throttle valve plate;
a first passage communicating with the first chamber to permit fluid flow into or out of the first chamber; and
a second passage communicating with the second chamber to permit fluid flow into or out of the second chamber.

2. The carburetor of claim 1 wherein the first passage has an inlet that is upstream of the throttle valve relative to a direction of fluid flow through the main bore and an outlet that is open to the valve bore, and the second passage has an inlet that is upstream of the throttle valve relative to a direction of fluid flow through the main bore and an outlet that is open to the valve bore.

3. The carburetor of claim 1 wherein the first passage has an inlet that is upstream of the throttle valve relative to a direction of fluid flow through the main bore and an outlet that is open to the valve bore, and the second passage has an outlet that is downstream of the throttle valve relative to a direction of fluid flow through the main bore and an inlet that is open to the valve bore.

4. The carburetor of claim 1 wherein the first passage has an outlet that is downstream of the throttle valve relative to a direction of fluid flow through the main bore and an inlet that is open to the valve bore, and the second passage has an inlet that is upstream of the throttle valve relative to a direction of fluid flow through the main bore and an outlet that is open to the valve bore.

5. The carburetor of claim 1 wherein the first passage has an outlet that is downstream of the throttle valve relative to a direction of fluid flow through the main bore and an inlet that is open to the valve bore, and the second passage has an outlet that is downstream of the throttle valve relative to a direction of fluid flow through the main bore and an inlet that is open to the valve bore.

6. A rotary throttle valve carburetor, comprising:
a main body having a main bore through which a fuel and air mixture is discharged, and a valve bore that intersects the main bore and has a bottom wall;
a throttle valve plate coupled to the main body and having an opening aligned with the valve bore;
a throttle valve received within the valve bore for rotation and axial movement between an idle position and a wide-open position, and wherein the throttle valve is closer to the bottom wall in the idle position than in the wide-open position, and the throttle valve extends into the opening in the throttle valve;
a first chamber defined in the valve bore between the bottom wall and the throttle valve;
a second chamber defined in the valve bore between the throttle valve and the throttle valve plate; and
at least one passage communicating with either the first chamber or the second chamber to permit fluid flow into or out of the first chamber or the second chamber, wherein the at least one passage is open when the throttle valve is in any position between and including the idle position and wide-open position.

7. The carburetor of claim 6 wherein said at least one passage has an inlet that is upstream of the throttle valve relative to a direction of fluid flow through the main bore and an outlet that is open to the first chamber.

8. The carburetor of claim 6 wherein said at least one passage has an inlet that is upstream of the throttle valve relative to a direction of fluid flow through the main bore and an outlet that is open to the second chamber.

9. The carburetor of claim 6 wherein said at least one passage has an outlet that is downstream of the throttle valve relative to a direction of fluid flow through the main bore and an inlet that is open to the first chamber.

10. The carburetor of claim 6 wherein said at least one passage has an outlet that is downstream of the throttle valve relative to a direction of fluid flow through the main bore and an inlet that is open to the second chamber.

11. The carburetor of claim 6 wherein said at least one passage includes a first passage communicating with the first chamber to permit fluid flow into or out of the first chamber, and a second passage communicating with the second chamber to permit fluid flow into or out of the second chamber.

12. The carburetor of claim 11 wherein the first passage has an inlet that is upstream of the throttle valve relative to a direction of fluid flow through the main bore and an outlet that is open to the valve bore, and the second passage has an outlet that is downstream of the throttle valve relative to a direction of fluid flow through the main bore and an inlet that is open to the valve bore.

13. The carburetor of claim 11 wherein the first passage has an outlet that is downstream of the throttle valve relative to a direction of fluid flow through the main bore and an inlet that is open to the valve bore, and the second passage has an inlet that is upstream of the throttle valve relative to a direction of fluid flow through the main bore and an outlet that is open to the valve bore.

14. The carburetor of claim 11 wherein the first passage has an outlet that is downstream of the throttle valve relative to a direction of fluid flow through the main bore and an inlet that is open to the valve bore, and the second passage has an outlet that is downstream of the throttle valve relative to a direction of fluid flow through the main bore and an inlet that is open to the valve bore.

15. The carburetor of claim 6 wherein said at least one passage includes a first passage having an inlet that is upstream of the throttle valve relative to a direction of fluid flow through the main bore and an outlet that is open to the first chamber, and a second passage having an outlet that is downstream of the throttle valve relative to a direction of fluid flow through the main bore and an inlet that is open to the first chamber.

16. The carburetor of claim 15 wherein said at least one passage includes a third passage having an inlet that is upstream of the throttle valve relative to a direction of fluid flow through the main bore and an outlet that is open to the second chamber.

17. The carburetor of claim 16 wherein said at least one passage includes a fourth passage having an outlet that is downstream of the throttle valve relative to a direction of fluid flow through the main bore and an inlet that is open to the second chamber.

18. The carburetor of claim 6 wherein said at least one passage includes a first passage having an inlet that is upstream of the throttle valve relative to a direction of fluid flow through the main bore and an outlet that is open to the second chamber, and a second passage having an outlet that is downstream of the throttle valve relative to a direction of fluid flow through the main bore and an inlet that is open to the second chamber.
